(19) United States
(12) Patent Application Publication
(10) Pub. No.: US 2015/0020754 A1
(43) Pub. Date: Jan. 22, 2015

(54) Pet Bathing Systems

(71) Applicant: Rigoberto Flores, JR., El Mirage, AZ (US)

(72) Inventor: Rigoberto Flores, JR., El Mirage, AZ (US)

(21) Appl. No.: 14/333,510

(22) Filed: Jul. 16, 2014

Related U.S. Application Data
(60) Provisional application No. 61/847,282, filed on Jul. 17, 2013.
(60) Provisional application No. 61/882,894, filed on Sep. 26, 2013.
(60) Provisional application No. 61/909,930, filed on Nov. 27, 2013.

(51) Int. Cl. A01K 13/00

(52) U.S. Cl. CPC A01K 13/006
USPC 119/815; 119/817

(57) ABSTRACT

A system for improved pet bathing of quadruped animals including feline species possessing claws and an aversion to water. More particularly, this invention relates to providing a system for restraining feline pets during bathing in a manner that is safe for both the owner and the animal.

### CROSS-REFERENCE TO RELATED APPLICATION

The present application is related to and claims priority from prior provisional application Ser. No. 61/847,282, filed Jul. 17, 2013, entitled “PET BATHING SYSTEMS”; and, this application is related to and claims priority from prior provisional application Ser. No. 61/882,894, filed Sep. 26, 2013, entitled “PET BATHING SYSTEMS”; and, this application is related to and claims priority from prior provisional application Ser. No. 61/909,930, filed Nov. 27, 2013, entitled “PET BATHING SYSTEMS”, the contents of all of which are incorporated herein by this reference and are not admitted to be prior art with respect to the present invention by the mention in this cross-reference section.

### BACKGROUND

This invention relates to providing a system for improved pet bathing of feline pets. More particularly, this invention relates to providing a system for restraining feline pets during bathing in a manner that is safe for both the owner and the animal.

Cats, as with many other animals, become dirty and collect parasites such as fleas over time. It is therefore often desirable for cat owners to occasionally bathe their pets. Experts recommend bathing cats regularly, with the frequency of bathing dependent on coat type, health, and level of activity. As many pet owners have experienced, however, most cats greatly dislike contact with water, often leading to scratching, biting or other physical injury. Because of this behavior, pet owners would be greatly assisted by a device allowing this necessary procedure to be conducted in a manner which is both safe for the owner and the animal itself.

### OBJECTS AND FEATURES OF THE INVENTION

A primary object and feature of the present invention is to provide a system overcoming the above-mentioned problem(s).

It is a further object and feature of the present invention to provide such a system that gently restrains certain anterior anatomical structures of the feline anatomy during bathing.

It is another object and feature of the present invention to provide such a system that includes adjustability features to accommodate cats of differing size.

It is a further object and feature of the present invention to provide such a system that includes a longitudinal hand grip(s) to assist the safe control of the pet during bathing.

It is another object and feature of the present invention to provide such a system that includes a head-surrounding guard to reduce the potential for biting.

It is another object and feature of the present invention to provide such a system that includes a removable foot guard to reduce the potential for scratching.

It is a further object and feature of the present invention to provide such a system that includes embodiments formed from water-compatible materials (including molded rubber).

A further primary object and feature of the present invention is to provide such a system that is efficient, inexpensive, and useful. Other objects and features of this invention will become apparent with reference to the following descriptions.

### SUMMARY OF THE INVENTION

In accordance with a preferred embodiment hereof, this invention provides a system, relating to the protective restraint of clawed quadrupeds during hygienic-care procedures, comprising: at least one bilateral forelimb restrainer structured and arranged to contemporaneously restrain both forelimbs of the clawed quadruped; wherein such at least one bilateral forelimb restrainer comprises at least one radial-ulnar restrainer structured and arranged to restrain motion of radial-ulnar portions of the forelimbs, at least one shoulder-motion restrainer structured and arranged to restrain at least rotational motion of the forelimbs about respective shoulder joints, and at least one liquid passage structured and arranged to enable passage of at least one liquid to exterior portions of the forelimbs during the hygienic-care procedures; wherein the restraint of the forelimbs by such at least one shoulder-motion restrainer prevents removal of the at least one radial-ulnar portion from such at least one radial-ulnar restrainer; and wherein such at least one radial-ulnar restrainer provides to the forelimbs a range of motion of independent of such at least one radial-ulnar restrainer during such restraint.

Moreover, it provides such a system wherein, during such restraint, such at least one bilateral forelimb restrainer provides unrestricted access to anatomical portions of the clawed quadrupeds at least posterior to a transverse plane bisecting the thoratic and lumbar vertebrae. Additionally, it provides such a system further comprising: at least one head shield structured and arranged to shield a head portion of the clawed quadruped; wherein such shielding reduces the potential for biting during the hygienic-care procedures.

Also, it provides such a system wherein such at least one bilateral forelimb restrainer comprises such at least one head shield. In addition, it provides such a system wherein: such at least one bilateral forelimb restrainer further comprises at least one hand grip structured and arranged to assist hand gripping of such at least one bilateral forelimb restrainer; wherein manual manipulation of the clawed quadruped is assisted during the hygienic-care procedures. And, it provides such a system wherein such at least one bilateral forelimb restrainer comprises at least one size adjuster structured and arranged to assist size adjustment of such at least one bilateral forelimb restraint to accommodate variously-size clawed quadrupeds. Further, it provides such a system wherein such at least one size adjuster comprises at least one size-adjustment strap. Even further, it provides such a system wherein such at least one size-adjustment strap is releasably secured by at least one hook-and-loop fastener.

Moreover, it provides such a system wherein such at least one bilateral forelimb restrainer further comprises at least one bilateral foot cover structured and arranged to bilaterally cover at least one foot portion of the forelimbs. Additionally, it provides such a system wherein such at least one bilateral foot cover is structured and arranged to be removably attached to such at least one bilateral forelimb restrainer. Also, it provides such a system wherein such at least one bilateral forelimb restrainer is constructed from at least one molded polymer. In addition, it provides such a system wherein such at least one bilateral forelimb restrainer is constructed from at least one waterproof resilient polymer.

In accordance with another preferred embodiment hereof, this invention provides a system, relating to the protective restraint of a cat during bathing, comprising: at least one bilateral forelimb restrainer structured and arranged to contemporaneously restrain both forelimbs of the cat; wherein such at least one bilateral forelimb restrainer comprises at least one radial-ulnar restrainer structured and arranged to restrain motion of radial-ulnar portions of the forelimbs, at least one shoulder-motion restrainer structured and arranged to restrain at least rotational motion of the forelimbs about respective shoulder joints, and at least one liquid passage structured and arranged to enable passage of at least one liquid to exterior portions of the forelimbs during the bathing; wherein the restraint of the forelimbs by such at least one shoulder-motion restrainer prevents removal of the at least one radial-ulnar portion from such at least one radial-ulnar restrainer; wherein such at least one radial-ulnar restrainer provides to the forelimbs a range of motion of independent of such at least one radial-ulnar restrainer during such restraint; wherein, during such restraint, such at least one bilateral forelimb restrainer provides unrestricted access to anatomical portions of the cat at least posterior to a transverse plane bisecting the thorax; and at least one head shield structured and arranged to shield a head portion of the cat; wherein such shielding reduces the potential for biting during the hygienic-care procedures.

And, it provides such a system wherein such at least one bilateral forelimb restrainer comprises such at least one head shield. Further, it provides such a system wherein: such at least one bilateral forelimb restrainer further comprises at least one hand grip structured and arranged to assist hand gripping of such at least one bilateral forelimb restrainer; wherein manual manipulation of the cat is assisted during the hygienic-care procedures. Even further, it provides such a system wherein such at least one bilateral forelimb restrainer comprises at least one size adjuster structured and arranged to assist size adjustment of such at least one bilateral forelimb restraint to accommodate variously-size cats. Moreover, it provides such a system wherein such at least one size adjuster comprises: at least one size-adjustment strap; and such at least one size-adjustment strap is releasably secured by at least one hook-and-loop fastener.

Additionally, it provides such a system wherein such at least one bilateral forelimb restrainer further comprises: at least one bilateral foot cover structured and arranged to bilaterally cover at least one foot portion of the forelimbs; wherein such at least one bilateral foot cover is structured and arranged to be removably attached to such at least one bilateral forelimb restrainer. Also, it provides such a system wherein such at least one bilateral forelimb restrainer is constructed from at least one resilient molded polymer.

In accordance with another preferred embodiment hereof, this invention provides a system, relating to the protective restraint of clawed quadrupeds during hygienic-care procedures, comprising: bilateral forelimb restraint means for contemporaneously restraining both forelimbs of the clawed quadruped; wherein such bilateral forelimb restraint means comprises radial-ulnar restraining means for restraining motion of radial-ulnar portions of the forelimbs, shoulder-motion restraining means for restraining at least rotational motion of the forelimbs about respective shoulder joints, and liquid passing means for enabling passage of at least one liquid to exterior portions of the forelimbs during the hygienic-care procedures; wherein the restraint of the forelimbs by such shoulder-motion restraining means prevents removal of the at least one radial-ulnar portion from such radial-ulnar restraining means; and wherein such radial-ulnar restraining means provides to the forelimbs a range of motion of independent of such radial-ulnar restraining means during such restraining In addition, it provides such a system wherein, during such restraint, such bilateral forelimb restraint means provides unrestricted access to anatomical portions of the clawed quadrupeds at least posterior to a transverse plane bisecting the thoratic and lumbar vertebrae.

Additionally, it provides such a system further comprising: head shielding means for shielding a head portion of the clawed quadruped; wherein such shielding reduces the potential for biting during the hygienic-care procedures. Further, it provides such a system wherein such bilateral forelimb restraint means comprises such head shielding means. Even further, it provides such a system wherein: such bilateral forelimb restraint means further comprises hand gripping means for assisting hand gripping of such bilateral forelimb restraint means; wherein manual manipulation of the clawed quadruped is assisted during the hygienic-care procedures. Even further, it provides such a system wherein such bilateral forelimb restraint means comprises size adjusting means for assisting size adjustment of such bilateral forelimb restraint means to accommodate variously-size clawed quadrupeds. Even further, it provides such a system wherein such size adjusting means comprises size adjustment/straps. Even further, it provides such a system wherein such bilateral forelimb restraint means further comprises bilateral foot covering means for bilaterally covering at least one foot portion of the forelimbs. Even further, it provides such a system wherein such bilateral foot covering means is removably attached to such bilateral forelimb restraint means.

In accordance with a preferred embodiment hereof, this invention provides each and every novel feature, element, combination, step and/or method disclosed or suggested by this patent application.

### BRIEF DESCRIPTION OF THE DRAWINGS

FIG. 1 shows a side view, illustrating a pet restraint device, operably engaged on a feline pet, according to a preferred embodiment of the present invention.

FIG. 2 shows a side view, further illustrating the pet restraint device, according to the preferred embodiment of FIG. 1.

FIG. 3 shows a front view, further illustrating the pet restraint device of FIG. 1.

FIG. 4 shows a diagrammatic anatomical depiction of the anterior skeletal structure of the feline pet of FIG. 1.

FIG. 5 shows an anatomical depiction of the skeletal structures of a feline forelimb.

FIG. 6 shows a diagrammatic free-body diagram, illustrating the freedom-of-movement constraints imposed by the pet restraint device, according to the preferred embodiment of FIG. 1.

FIG. 7 shows a side view, illustrating an alternate pet restraint device, operably engaged on a feline pet, according to another preferred embodiment of the present invention.

FIG. 8 shows a perspective view, illustrating a removable boot, according to the alternate preferred embodiment of FIG. 7.

FIG. 9 shows a side view, illustrating an alternate pet restraint device, operably engaged on a feline pet, according to another preferred embodiment of the present invention.

FIG. 10 shows a top view, illustrating the alternate pet restraint device of FIG. 9, operably engaged on a feline pet.

FIG. 11 shows a diagrammatic depiction of a liquid-permeable material, according to preferred embodiments of the present invention.

FIG. 12 shows a diagrammatic depiction of another liquid-permeable material, according to preferred embodiments of the present invention.

FIG. 13 shows a sectional view, through the section 13-13 of FIG. 12, illustrating a rigid stiffening member, according to preferred embodiments of the present invention.

FIG. 14 shows a rear perspective view, illustrating an alternate pet restraint device, according to another preferred embodiment of the present invention.

FIG. 15A shows a partially exploded side view illustrating the alternate pet restraint device of FIG. 14.

FIG. 15B shows a side view illustrating the alternate pet restraint device of FIG. 14.

FIG. 16A shows a rear perspective view, illustrating a removable handle subsystem, according to the alternate preferred embodiment of FIG. 14.

FIG. 16B shows a side perspective view, illustrating the removable handle subsystem, according to the alternate preferred embodiment of FIG. 14.

FIG. 17 shows a bottom view, illustrating the removable handle subsystem, according to the alternate preferred embodiment of FIG. 14.

FIG. 18 shows a front view illustrating the alternate pet restraint device of FIG. 14.

FIG. 19 shows a rear view illustrating the alternate pet restraint device opened to receive a pet, according to the preferred embodiment of FIG. 14.

FIG. 20 through FIG. 25 show a plan view, illustrating a flat pattern of the alternate pet restraint device, according to the preferred embodiment of FIG. 14.

### DETAILED DESCRIPTION OF THE BEST MODES AND PREFERRED EMBODIMENTS OF THE INVENTION

Most cats have an instinctual aversion to water. For this reason, feline pets often exhibit aggressive behavior during bathing or similar hygienic procedures involving water. Such instinctive fear behavior is typically defensive in nature and may include swatting, striking with paws, and biting. Such behaviors can result in the infliction of bites and lacerations, which are painful and can easily become infected.

Of all domestic animals, the cat is one of the most difficult to handle; they are physically agile and adept at escaping restraints during stressful situations. Applicant's pet-restraining devices are preferably configured to restrain cats, and other clawed animals, during bathing in a manner that is safe for both the pet care giver and the animal.

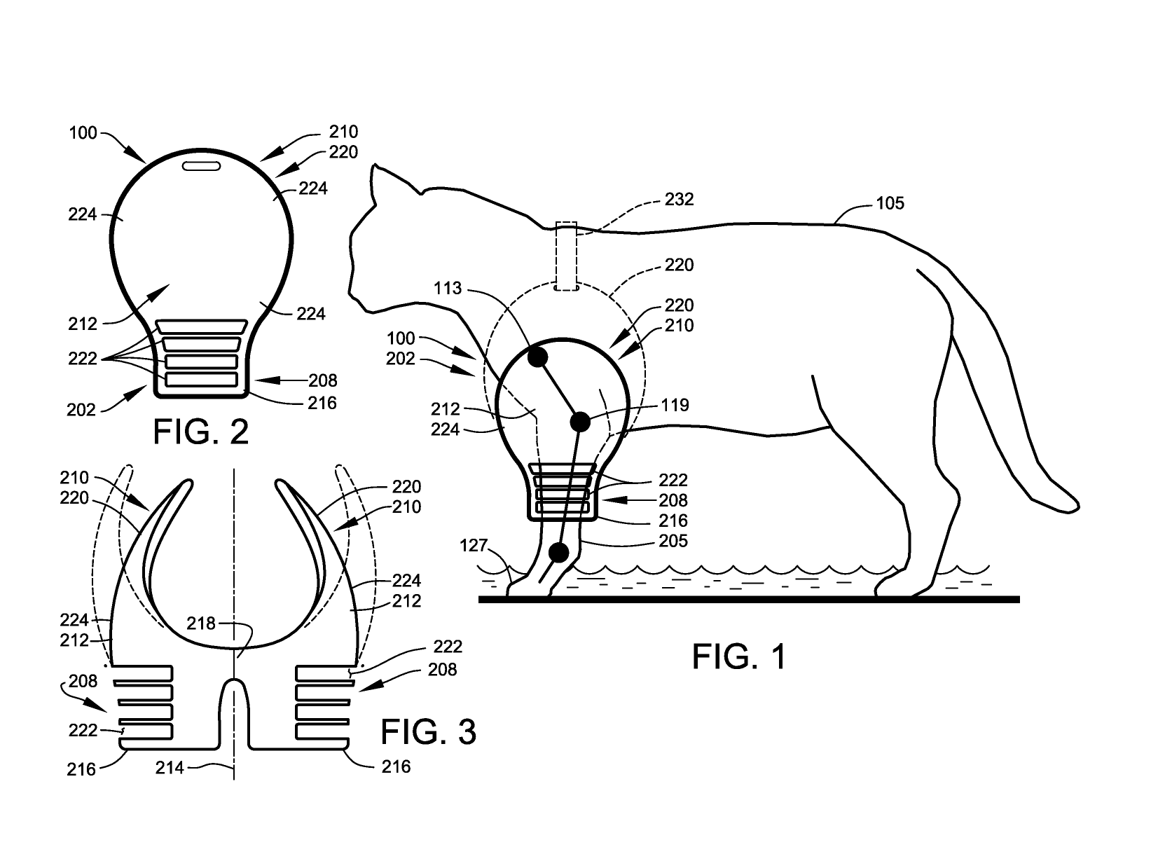

FIG. 1 shows a side view, illustrating pet restraint device 202, operably engaged on a feline pet 105 (i.e., a clawed quadrupeds of the cat family), according to a preferred embodiment of the present invention. Applicant's pet restraint device 202 is preferably designed to limit the mobility of feline pet 105 without unduly limiting access to the outer body of the pet during bathing procedures. Applicant's pet restraint devices 100, including pet restraint device 202, are preferably designed to contemporaneously restrain both forelimbs 205 of the subject animal using the least amount of restraint necessary to safely accomplish the required hygienic procedures. Thus, the subject animal is limited in its ability to perform instinctive defensive maneuvers utilizing its claws 127.

During development of the presently-disclosed restraint system, Applicant made an unexpected discovery regarding a specific feline behavior. Applicant noticed that most domestic cats will refrain from hind-leg defensive scratching when the mobility of the cat's forelegs is sufficiently restricted. Applicant noted that subject cats would consistently suppress defensive actions utilizing their hind legs in favor of reflexive actions to correct and maintain balance. Applicant speculates that reflexive behaviors relating to balance and body positioning supersede at least some instinctive defensive behaviors. This discovery allowed Applicant to design a restraint system that allows unrestricted access the posterior regions of the animal by implementing some restraint of the forelimbs, as shown in FIG. 1, FIG. 2, and FIG. 3.

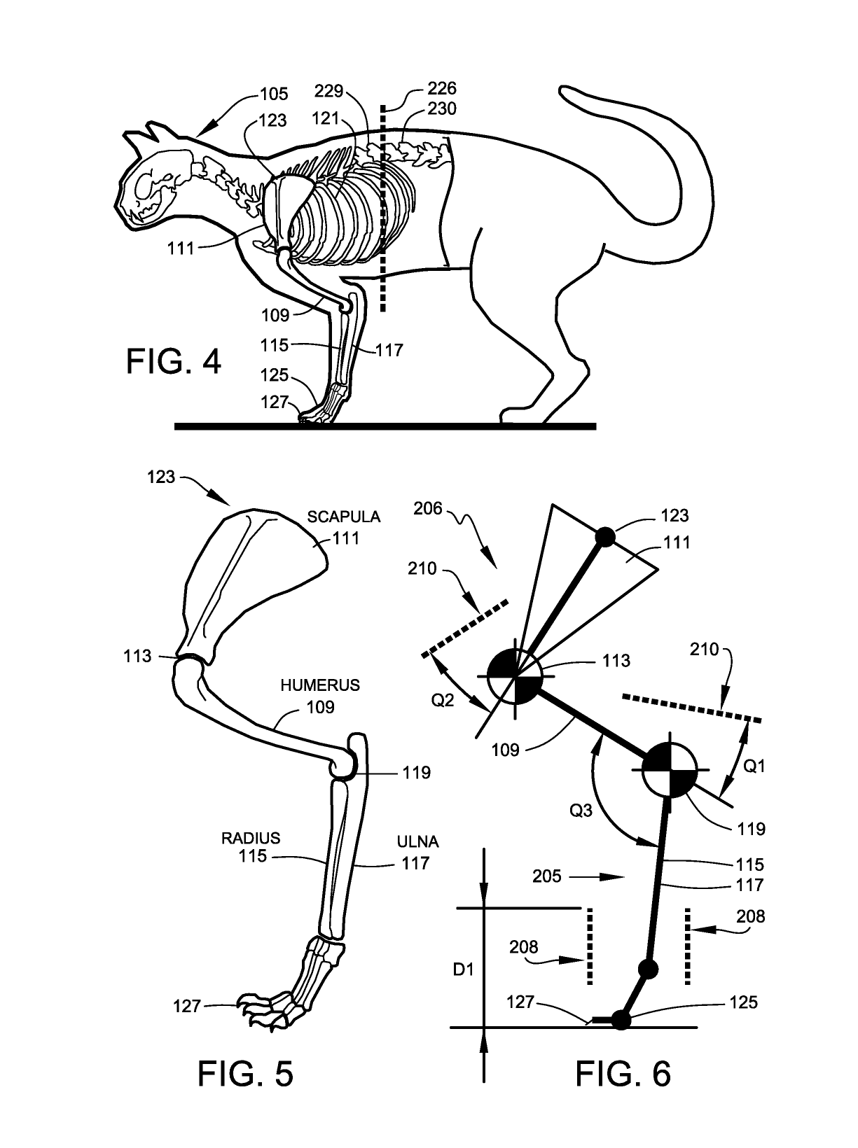

To understand the principals of operation of Applicant's devices, including pet restraint device 202, it is helpful to review the anterior skeletal anatomy of a cat. In this regard, FIG. 4 shows an “X-ray” diagrammatic anatomical depiction of the anterior skeletal structure of feline pet 105 of FIG. 1. FIG. 5 shows an isolated anatomical depiction of the skeletal structures of a feline forelimb 205. Beginning with the central bone of the forelimb, the humerus 109 is a single elongated bone, which articulates with the upper scapula 111 to form shoulder joint 113, and the lower radius 115 and ulna 117 to form elbow joint 119, as shown. Elbow joint 119 is a compound joint including a hinge joint between humerus 109 and the lower radius 115 and ulna 117 and a pivot joint between radius 115 and ulna 117.

Shoulder joint 113 is a ball and socket joint capable of flexion, extension, abduction, adduction, internal rotation, external rotation, and circumduction. Its primary motion, however, is flexion and extension in that the joint operates chiefly as a hinge joint due to extensive muscling around the articulation.

The articulation between scapula 111 and adjacent thorax 121 is referred to herein as scapulothoracic joint 123; although, scapulothoracic joint 123 is not a true anatomic joint in the sense in that it has no capsule or ligamentous attachments. It does, however, have relevance in that scapulothoracic joint 123 produces several freedoms of forelimb movement that must be controlled by the structures and functions of applicant's restraint devices.

FIG. 6 shows a diagrammatic free-body diagram representing the forelimb 205 of feline pet 105, including rotations, translations and freedom-of-movement constraints (i.e., limiting forces) acting upon the forelimb. For simplicity of explanation, the rigid bodies and joints of the free-body diagram will be identified using the same component numbers as those used in FIG. 5.

Referring to the free-body diagram of FIG. 6, the preferred embodiments of the present system preferably comprise a bilateral forelimb restrainer 206 that preferably implements at least two principal constraints to forelimb movement (at least embodying herein bilateral forelimb restraint means for contemporaneously restraining both forelimbs of the clawed quadruped).

First, bilateral forelimb restrainer 206 comprises at least one radial-ulnar restrainer 208 configured to restrain motion of the lower radius 115 and ulna 117 about elbow joint 119, as shown. (at least embodying herein radial-ulnar restraining means for restraining motion of radial-ulnar portions of the forelimbs). The free-body diagram of FIG. 6 indicates radial-ulnar restrainer 208 as two opposing vertical lines located anteriorly and posteriorly of radius 115 and ulna 117. These fixed lines suggest the bounds and limits of flexion and extension of the lower forelimb about elbow joint 119. Thus, the limit of angular rotation Q3 of the lower forelimb about elbow joint 119 is determined by the impingement of the lower forelimb on the fixed structures of radial-ulnar restrainer 208.

Secondarily, bilateral forelimb restrainer 206 comprises at least one shoulder-motion restrainer 210 structured and arranged to restrain at least the rotational motion of forelimbs 205 about respective shoulder joints 113 (at least embodying herein shoulder-motion restraining means for restraining at least rotational motion of the forelimbs about respective shoulder joints). The free-body diagram of FIG. 6 indicates shoulder-motion restrainer 210 as two additional fixed lines, which define the preferred boundaries of motion of the upper portions of forelimbs 205. The first of the two boundary lines, located above and adjacent to elbow joint 119 indicates the limit of angular rotation Q1 of humerus 109 about shoulder joint 113. The second of the two boundary lines, located above and forward of elbow joint 119 indicates the limit of movement Q2 of shoulder joint 113 in relation to the scapulothoracic joint 123. It should be noted that the articulation of scapulothoracic joint 123 has been somewhat simplified; however, the primary anterior-posterior translation of humerus 109 is sufficiently represented as to demonstrate the critical motion restraints implemented within applicant's preferred apparatus.

The primary function of shoulder-motion restrainer 210 is to prevent lifting of the paw 125 (and claws 127) above and beyond the constraint structures of radial-ulnar restrainer 208. Thus, shoulder-motion restrainer 210 prevents paw 125 from moving a distance D1 greater than the restraint limits of radial-ulnar restrainer 208.

It is important to note that the bilateral forelimb restrainer 206 does not function to fully immobilize forelimb. Preferably, pet restraint device 202 is structured and arranged to provide a gap or space between the forelimb of the animal and pet restraint device 202. There are two reasons for this preferred implementation. One is that water, or other bathing liquids, is able to flow under pet restraint device 202 to contact the outer coat and epidermis of forelimbs 205 during the hygienic-care procedures (at least embodying herein liquid passing means for enabling passage of at least one liquid to exterior portions of the forelimbs during the hygienic-care procedures).

The second is that anxiety and fear aggression is often triggered when a cat perceives a threat, and senses that it cannot escape. The preferred lack of tightly-engaged restraints is believed to help the restrained animal remain calm, by reducing the immediate sensory feedbacks associated with restraint. This is in contrast to other restraint methodologies, such as, for example, close-fitting harnesses, bindings, wraps, etc. Pet restraint device 202 is preferably configured to allow the upper and lower portions of each forelimb 205 to move independently, within the defined motion limits, to further reduce the animal's perception of restraint (at least embodying herein wherein such radial-ulnar restraining means provides to the forelimbs a range of motion independent of such radial-ulnar restraining means during such restraining)

Referring to the illustrations of FIG. 2 and FIG. 3, FIG. 2 shows a side view, illustrating pet restraint device 202, according to the preferred embodiment of FIG. 1. FIG. 3 shows a front view, of the pet restraint device 202 of FIG. 1. Pet restraint device 202 preferably comprises a pre-formed body 212 designed to firmly engage both forelimbs 205 of feline pet, including the anatomical structures of the shoulders. Body 212 is preferably bilaterally symmetrical about plane 214, which when engaged on the subject animal generally aligns with the sagittal plane.

Pet restraint device 202 preferably comprises a bilateral set of forelimb-receiving sleeves 216, which are preferably configured to loosely encircle the lower portion of forelimbs 205. Sleeves 216 preferably perform the functions of the above-described radial-ulnar restrainers 208, which preferably restrain motion of the lower forelimb about elbow joint 119. Each sleeve comprises an elliptically-shaped inner passage through which the paw 125 and lower portion of forelimb 205 passes.

Each sleeve 216 preferably comprises a cup-shaped upper shoulder restraint 220 that is preferably configured to engage the anatomical structures of the shoulder. Each shoulder restraint 220 is integrally formed with an adjacent sleeve and preferably comprises a substantially rigid boundary wall 224 that preferably performs the functions of shoulder-motion restrainer 210; thus, boundary wall 224 preferably prevents movements of the upper forelimb that would otherwise enable lifting of a paw above and beyond the constraint structures of sleeve 216.

Both sleeves 216 and their integral shoulder restraints 220 are preferably sized to fit a common range of subject animals. Alternate preferred embodiments comprise larger (or smaller) upper shoulder restraints 220 to accommodate larger (or smaller/juvenile) cat anatomies, preferably by comprising upper shoulder restraints 220 of alternate sizing, as indicated by the dashed-line depiction of FIG. 1.

The bilateral sleeves 216 are preferably coupled by an integrally-formed connector 218 located centrally below the thorax 121, as best shown in FIG. 1, FIG. 3 and FIG. 4. A set of aperture openings 222 permit liquids to flow through body 212 and allows access to the external features of the forelimbs during the bathing procedures. In should be noted that the size, shape, frequency, and placement of aperture openings 222 may vary between embodiments of the system. Alternate preferred aperture arrangements, suitable for use in the present embodiment, are shown in FIG. 11 and FIG. 12.

Body 212 is preferably constructed from at least one water-resistant material, preferably a moldable rubber, more preferably moldable synthetic polymer having a mechanical rigidity engineered to implement an appropriate level of forelimb restraint. One preferred material comprises a synthetic polymer having a chemical formulation providing a balance between rigidity and flexibility. Such a material is preferably formulated to possess sufficient rigidity to restrict the mobility of the forelimbs 205, as described above, and sufficient resilient elasticity so as to permit body 212 of pet restraint device 202 to be deflected outwardly (as illustrated by the dashed-line depiction of FIG. 3) to enable placement over the animal. In the deflected-opened configuration, the forelimbs 205 and adjacent shoulder regions of the animal can be located within restraint device 202, as generally illustrated in FIG. 1. Once the animal is so engaged, the preferred resiliency of the material forming body 212 allows the device to return to its former shape, thereby gently but firmly capturing the forelimbs 205 and adjacent shoulder regions of the animal within pet restraint device 202. Upon reading this specification, those with ordinary skill in the art will now appreciate that, under appropriate circumstances, considering such issues as design preference, user preferences, marketing preferences, cost, structural requirements, available materials, technological advances, etc., other material arrangements such as, for example, natural rubbers, rigid plastics, composite materials, materials containing anti-microbial compounds, etc., may suffice.

Furthermore, preferred embodiments of shoulder restraint 220 are preferably equipped with one or more accessory holding straps 232 that preferably function to further assist in firmly retaining pet restraint device 202 adjacent the subject animal.

With specific reference to FIG. 4, the preferred embodiments of the present system provide, when restraining an animal, unrestricted access to anatomical portions of the subject animal. In more specific terms, the preferred embodiments of the present system are preferably configured to provide unrestricted access to anatomical portions of the subject animal posterior to a transverse plane 226 roughly bisecting the thoratic vertebrae 229 and lumbar vertebrae 230, as shown (at least embodying herein wherein, during such restraint, such at least one bilateral forelimb restrainer provides unrestricted access to anatomical portions of the clawed quadrupeds at least posterior to a transverse plane bisecting the thoratic and lumbar vertebrae).

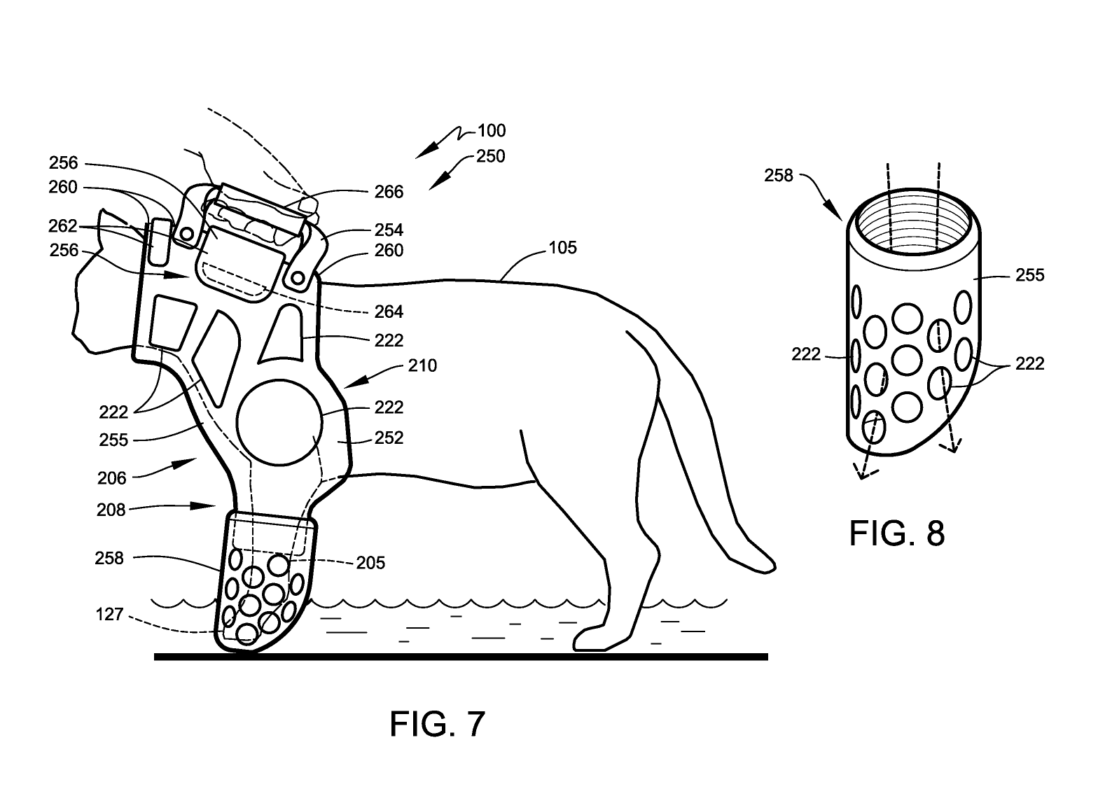

FIG. 7 shows a side view, illustrating alternate pet restraint device 250, operably engaged on feline pet 105, according to another preferred embodiment of the present invention. Alternate pet restraint device 250 is preferably designed to limit the mobility of feline pet 105 without unduly limiting access to the outer body of the pet during bathing procedures. Alternate pet restraint device 250 preferably comprises physical features structured and arranged to form a bilateral forelimb restrainer 206 including radial-ulnar restrainers 208 and shoulder-motion restrainers 210. Alternate pet restraint device 250 preferably differs from the prior-described pet restraint device 202 in that the alternate embodiment comprises additional features further enhancing the functionality of the apparatus. These preferred features include:
a) a more flexible restraint body 252 configured to extend upwardly over the neck and back of the animal;
b) at least one hand grip 254 structured and arranged to assist hand gripping of the apparatus during the bathing procedure;
c) one or more size adjusters 256 structured and arranged to assist size adjustment of restraint body 252 to accommodate variously-size animals; and
d) a set of boots 258 structured and arranged to bilaterally cover the lower portions of forelimbs 205 including the claws 127.

As with the prior embodiment, restraint body 252 of alternate pet restraint device 250 is preferably constructed from at least one water-resistant material 255, preferably a non-toxic natural or synthetic rubber. Preferred synthetic polymers include styrene-butadiene rubbers and similar elastomers. The resilient rubber material forming the device preferably comprises an engineered level of mechanical resilience, suitable to implement an appropriate level of forelimb restraint. Restraint body 254 preferably comprises a durometer shore hardness falling between a shore A rating of about 40 and about 70 (which may be described as falling somewhere between a medium-soft pencil eraser and a medium-hard vehicle tire).

Restraint body 254 is preferably fabricated in a manner providing a roughly pre-formed shape, as depicted in FIG. 7. Preferred fabrication methods include the use of at least one molding process, such as, for example, injection molding, compression molding, transfer molding, etc. (at least embodying herein wherein such at least one bilateral forelimb restrainer is constructed from at least one molded polymer). Upon reading this specification, those with ordinary skill in the art will now appreciate that, under appropriate circumstances, considering such issues as design preference, user preferences, marketing preferences, cost, structural requirements, available materials, technological advances, etc., other fabrication methods such as, for example, die-cutting body components from rubber sheets, etc., may suffice.

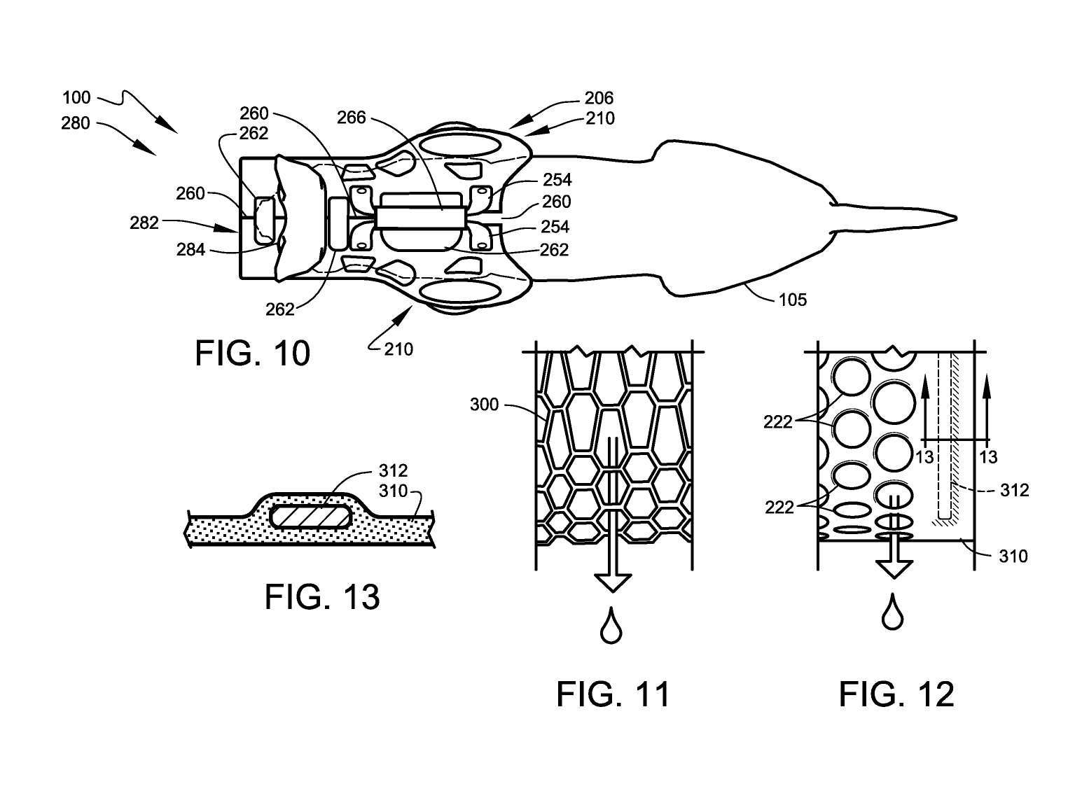

Restraint body 252 preferably extends upwardly over the neck and back of the subject animal and preferably terminates at a continuous linear upper seam 260, which preferably extends approximately longitudinally along the spine of the subject animal. Preferably, upper seam 260 is drawn together and secured in a closed configuration by one or more closure flaps 262, as shown (see also the top view of FIG. 10). These strap-like closure flaps 262 are preferably length adjustable to permit a caregiver to custom-fit the device to match the anatomical size of a particular animal (at least embodying herein wherein such at least one bilateral forelimb restrainer comprises at least one size adjuster structured and arranged to assist size adjustment of such at least one bilateral forelimb restraint to accommodate variously-size cats). Thus, closure flaps 262 preferably function as size adjusters 256 to assist a caregiver in securing the subject animal within the device in a manner that is both secure and comfortable for the subject animal.

Preferably, closure flaps 262 (at least embodying herein at least one size-adjustment strap) is releasably secured by at least one hook-and-loop fastener 264 (hidden, as indicated by the dashed-line depiction). Preferred hook-and-loop fasteners 264, suitable for use in the present embodiment, are distributed under the Velcro® trade name. Upon reading this specification, those with ordinary skill in the art will now appreciate that, under appropriate circumstances, considering such issues as design preference, user preferences, marketing preferences, cost, structural requirements, available materials, technological advances, etc., other size-adjustment arrangements such as, for example, buckles, snaps, ties, etc., may suffice.

Hand grip 254 is preferably located in a dorsal position over the spine, as shown. It preferred that hand grip 254 is oriented longitudinally above upper seam 260, as shown; however, hand grip 254 may alternately comprise other functional orientations. Hand grip 254 is preferably configured assist manual manipulation of the apparatus and subject animal during the bathing procedure. Hand grip 254 may preferably comprise two separate straps that converge at a hook-and-loop secured grip 266, as shown. Alternately preferably, hand grip 254 may comprise an integrally-formed rubber member extending from restraint body 254.

Restraint body 252 preferably comprises a set of aperture openings 222 to permit liquids to flow through restraint body 252 and to provide access to the external features of the forelimbs during the bathing procedures. In should be noted that the size, shape, frequency, and placement of aperture openings 222 may vary between embodiments of the system. Alternate preferred aperture arrangements, suitable for use in the present embodiment, are shown in FIG. 11 and FIG. 12.

FIG. 8 shows a perspective view, illustrating boot 258, according to the alternate preferred embodiment of FIG. 7. Boots 258 are preferably configured to be removable from the lower forelimb-receiving sleeves 266 of restraint body 252. Each boot 258 preferably comprises an arrangement of aperture openings 222 to permit liquids to flow through boot 258 and to provide access to the external features of the lower forelimbs. Boots 258 are preferably constructed from the same resilient material as restraint body 252. When joined with forelimb-receiving sleeves 266, boot 258 protectively cover the claws 127 of the subject animal, as shown.

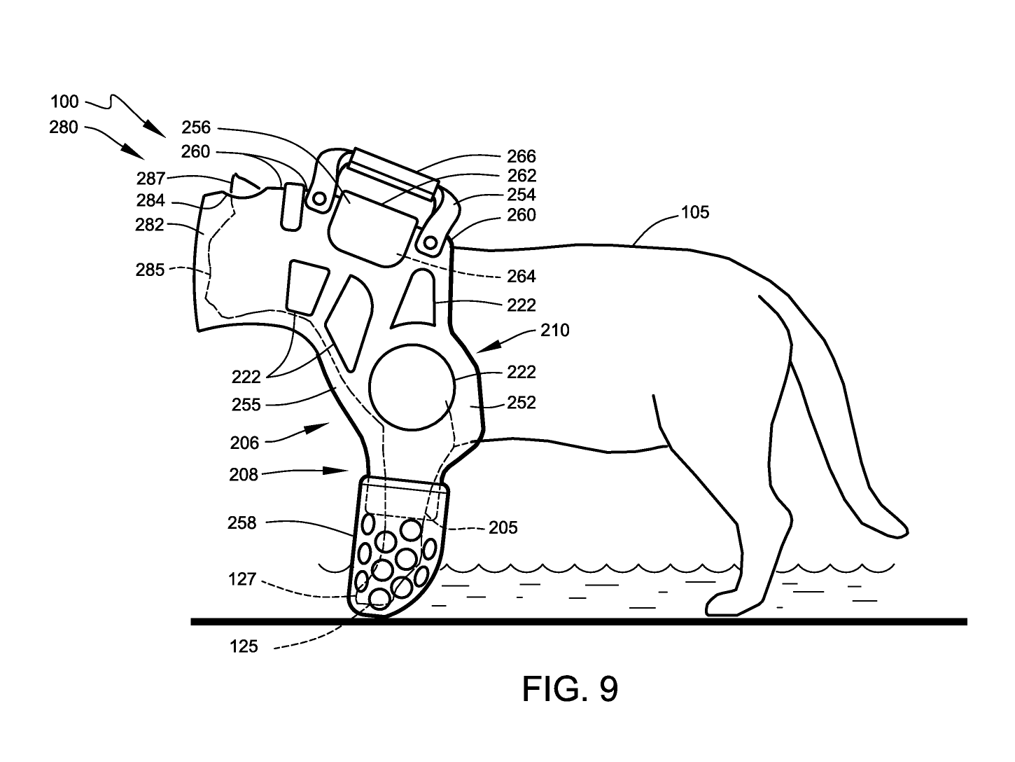

FIG. 9 shows a side view, illustrating an alternate pet restraint device 280, operably engaged on feline pet 105, according to another preferred embodiment of the present invention. Alternate pet restraint device 280 is preferably designed to limit the mobility of feline pet 105 without unduly limiting access to the outer body of the pet during bathing procedures. Alternate pet restraint device 280 preferably comprises physical features structured and arranged to form a bilateral forelimb restrainer 206 including radial-ulnar restrainers 208 and shoulder-motion restrainers 210. Alternate pet restraint device 280 preferably differs from the prior-described alternate pet restraint device 250 in that the present alternate embodiment comprises an additional head shield 282 that is structured and arranged to shield a head portion 285 of the subject animal. Head shield 282 is preferably configured to surround the head portion 285 to prevent biting.

FIG. 10 shows a top view, illustrating alternate pet restraint device 280 of FIG. 9 including the preferred head shield 282. When secured over the subject animal, head shield 282 preferably form a cylindrical or frustoconical hollow sleeve having an anterior end that is substantially open, as shown. It is preferred that head shield 282 be integrally formed with restraint body 252, as shown. Furthermore, head shield 282 preferably comprises one or more openings 284 to accommodate the ears 287 of the subject animal.

FIG. 11 shows a diagrammatic depiction of an alternate preferred liquid-permeable material 300, according to preferred embodiments of the present invention. Liquid-permeable material 300 preferably comprises a substantially rigid (or alternately preferably, semi-rigid) open-latticed structure that is capable of durably restraining the forelimbs of the subject animal. The key advantage of such a structural material is the relatively high percentage of open area, which permits water or other bathing liquids to flow through the support structures of the apparatus to contact the outer coat and epidermis of forelimbs 205 during the hygienic-care procedures. Furthermore, the openings provide access to the outer coat and epidermis to permit direct manipulation. Materials suitable for the fabrication of liquid-permeable material 300 include molded plastics and moderately stiff synthetic rubbers.

FIG. 12 shows a diagrammatic depiction of another liquid-permeable material 310, according to preferred embodiments of the present invention. FIG. 13 shows a sectional view, through the section 13-13 of FIG. 12, illustrating a rigid stiffening member 312, according to preferred embodiments of the present invention.

Alternate liquid-permeable material 310 preferably includes a regular (or alternately preferably, random) pattern of aperture openings 222, as shown. These perforations enable water or other bathing liquids to flow through liquid-permeable material 310 permit direct access to the forelimbs during cleaning. Rigid stiffening members 312 may be co-molded within the material to add structural rigidity, as needed. Preferred rigid stiffening members 312 are pre-formed to generally match the anatomical shape of the subject animal. Alternately preferably, rigid stiffening members 312 comprise a bendable material, such as aluminum, to permit “custom” fitting of the apparatus to the subject animal.

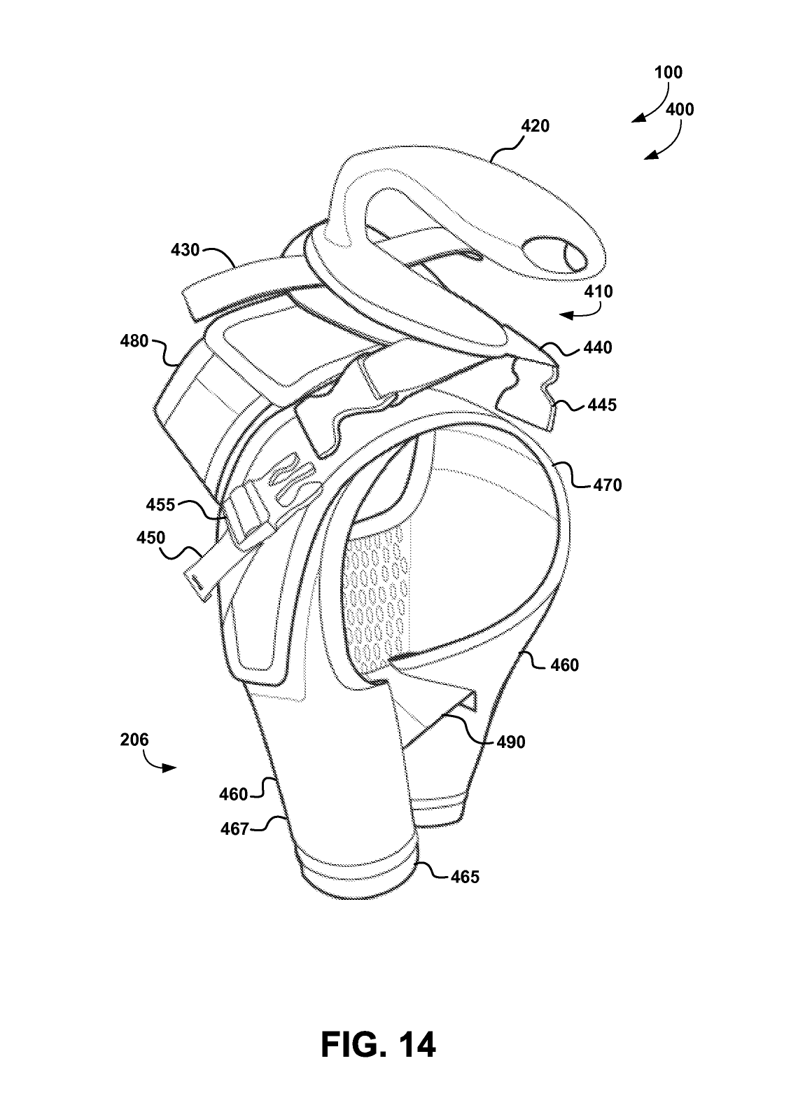

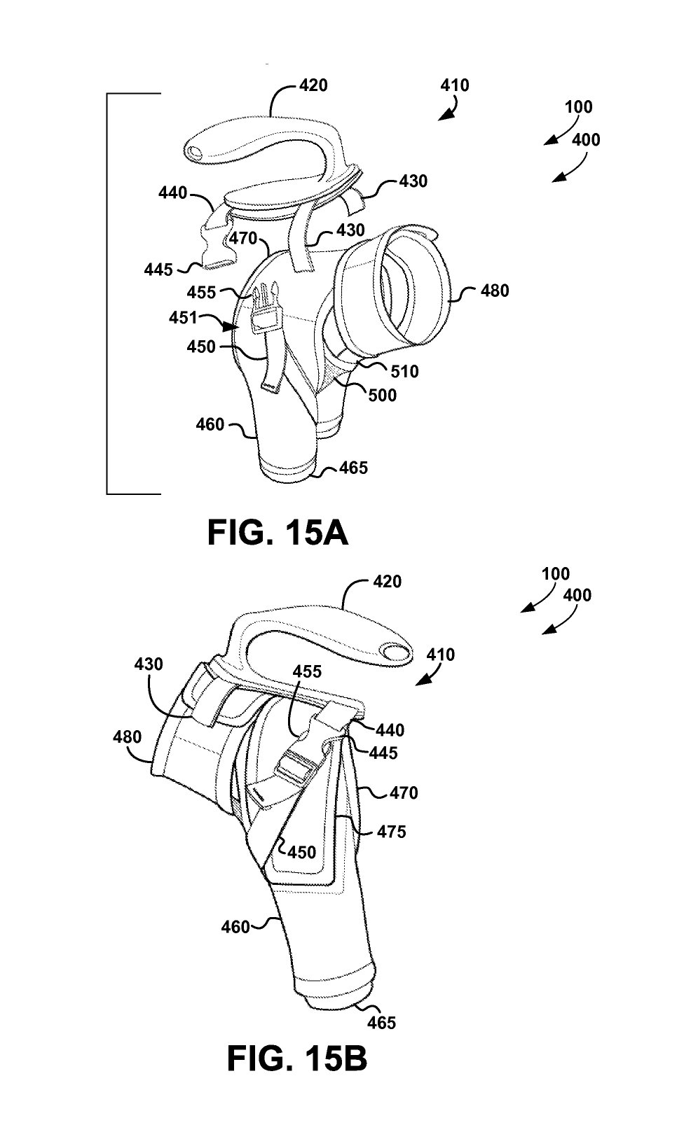

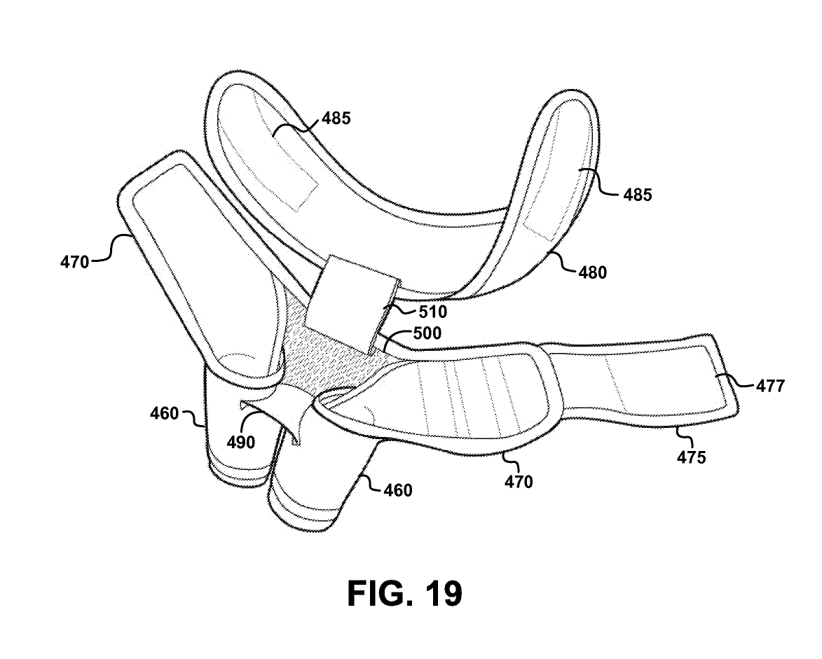

FIG. 14 shows a rear perspective view, illustrating an alternate pet restraint device 400, according to another preferred embodiment of the present invention. FIG. 15A shows a partially exploded side view illustrating alternate pet restraint device 400 of FIG. 14. FIG. 15B shows a side view illustrating alternate pet restraint device 400 of FIG. 14. FIG. 18 shows a front view illustrating alternate pet restraint device 400 of FIG. 14. FIG. 19 shows a rear view illustrating alternate pet restraint device 400 opened to receive a pet, according to the preferred embodiment of FIG. 14. Alternate pet restraint device 400 preferably utilizes similar principles as outlined for other embodiments of the present invention, particularly to restrain and calm the subject animal. Alternate pet restraint device 400 preferably comprises a pair of leg restraints 460, at least one body wrap 470, at least one neck wrap 480, and at least one removable handle subsystem 410.

Leg restraints 460 preferably comprise radial-ulnar restrainer 208. Each leg restraint 460 preferably comprises at least one hollow tube of material, permitting the insertion of one foreleg of the subject animal in each leg restraint 460. Each leg restraint 460 preferably comprises at least one rigid component, preferably at least one rigid interior tube 465. Upon reading the teachings of this specification, those skilled in the art will now appreciate that, under appropriate circumstances, considering such issues as cost, available materials, etc., other rigid components, such as, for example, rigid helicals, rigid ribbing, rigid lattices, etc., may suffice.

Rigid interior tube 465 preferably comprises rigid plastic. Upon reading the teachings of this specification, those skilled in the art will now appreciate that, under appropriate circumstances, considering such issues as cost, available materials, etc., other rigid materials, such as, for example, ceramets, ceramics, metals, etc., may suffice.

Rigid interior tube 465 preferably comprises a length sufficient to extend a minimum of beyond the third joint (joining leg to foot) about 1/16 of the distance between the second joint (elbow joint 119) and the third joint and a maximum to exceed the total length of the leg (measured from the shoulder to the bottom of the foot when the animal is standing unassisted) by about ¼ of the total length of the leg. Rigid interior tube 465 preferably comprises a circumference between about 1/16 inch larger than the circumference of the leg between the second joint and third joint of the leg and about twice the circumference of the leg between the second joint and third joint of the leg. For reference, Applicant has found that on average the leg length of a house cat ranges from about 3 inches to about 18 inches in total length. In preferred embodiments of the present system, the tubes permit liquid to pass adjacent the front leg to facilitate cleaning In preferred embodiments of the present system, the tubes comprise removable/adjustable distal caps.

Rigid interior tube 465 preferably is surrounded by at least one outer layer 467 comprising flexible material. Outer layer 467 preferably comprises neoprene, preferably neoprene with edge binding. Upon reading the teachings of this specification, those skilled in the art will now appreciate that, under appropriate circumstances, considering such issues as cost, available materials, etc., other flexible materials, such as, for example, other non-reactive polymers, fabrics, etc., may suffice.

Outer layer 467 preferably materially extends into body wrap 470. Leg restraints 460 preferably couple on the inside portion of leg restraints 460, preferably using at least one leg material connector 490. Leg material connector 490 preferably connects to outer layer 467 on each leg restraint 460. In use, leg material connector 490 lies across the chest of the subject animal. Leg material connector 490 preferably comprises elastic material.

Body wrap 470 preferably comprises shoulder-motion restrainer 210. Body wrap 470 preferably comprises a flexible material, preferably neoprene. Materially, body wrap 470 preferably is an extension of the material forming leg restraints 460. Body wrap 470 preferably adjusts in size to accommodate variances in size of the subject animal. Body wrap 470 preferably wraps the circumference of body of the subject animal anterior to transverse plane 226. Body wrap 470 preferably comprises chest portion 500. Chest portion 500 preferably comprises at least one mesh material. Chest portion 500 preferably permits water to pass through preventing collection of water against the chest of the subject animal and permitting washing of the chest area. Upon reading the teachings of this specification, those skilled in the art will now appreciate that, under appropriate circumstances, considering such issues as cost, available materials, etc., other water passing materials, such as, for example, lacings, webbings, other open materials, etc., may suffice.

Body wrap 470 preferably securely holds the subject animal firmly, yet comfortably around the rig cage area of the animal. Body wrap 470 preferably comprises hook-and-loop fasteners 485, preferably providing firm, comfortable and secure holding on a variety of chest sizes of various individual animals. Further Hook-and-loop fasteners 485 allow ease of opening and closing body wrap 470 in use. In use, Body wrap 470 and leg restraints 460 together comprise bilateral forelimb restrainer 206.

Neck wrap 480 preferably comprises at least one neck restraint, preferably restraining the head movement of the subject animal. Neck wrap 480 preferably comprises flexible material, preferably neoprene. Neck wrap 480 preferably encircles the neck of the subject animal. Neck wrap 480 preferably couples with body wrap 470, preferably with neck wrap connector 510. Neck wrap connector 510 preferably comprises at least one flexible material, preferably webbing. Neck wrap connector 510 preferably connects between neck wrap 480 and chest portion 500.

To fully restrain the head and provide proper support for the subject animal during use, neck wrap 480, body wrap 470 and leg restraints 460 preferably couple to removable handle subsystem 410. Removable handle subsystem preferably comprises at least two neck wrap straps 430 and at least two body straps 440. Neck wrap straps 430 preferably connect with neck wrap 480. Neck wrap straps 430 preferably comprise hook-and-loop fasteners. Each body strap 440 preferably comprises at least one buckle receiver 445. Assembly of body wrap 470 and leg restrainers 460 preferably comprise at least two body straps 450, preferably comprising buckle 455 and at least one length adjuster 457. In use, buckle receiver 445 preferably couples with buckle 455. Body straps 450 preferably extend across body wrap 470 and connect, near chest portion 500, to leg restraints 460. This structural arrangement securely supports and restrains the chest and legs of the subject animal in use.

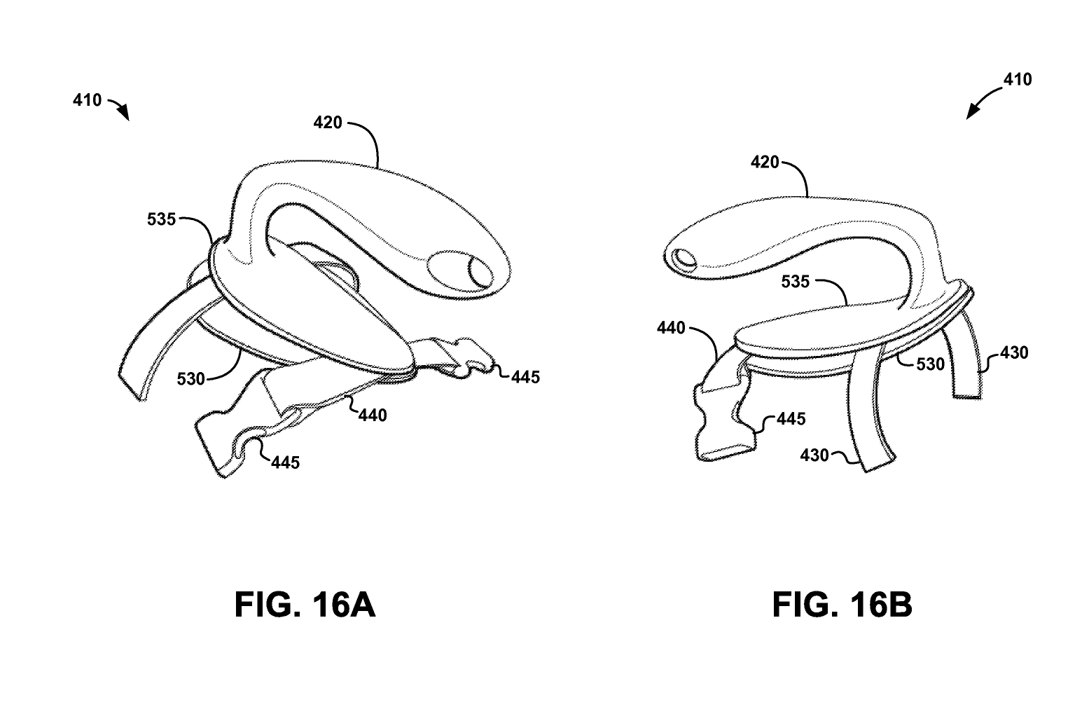

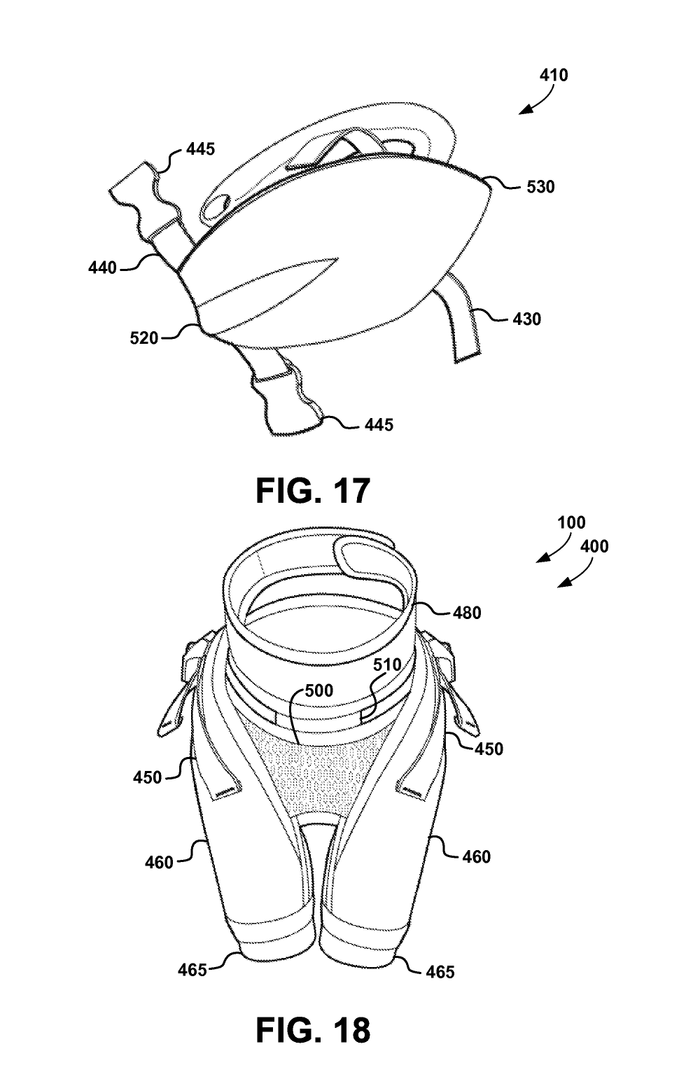

FIG. 16A shows a rear perspective view, illustrating a removable handle subsystem 410, according to the alternate preferred embodiment of FIG. 14. FIG. 16B shows a side perspective view, illustrating removable handle subsystem 410, according to the alternate preferred embodiment of FIG. 14. FIG. 17 shows a bottom view, illustrating removable handle subsystem 410, according to the alternate preferred embodiment of FIG. 14.

Removable handle subsystem 410 preferably further comprises at least one handle 420, at least one support distributor 530 and at least one support connector 535. Neck wrap straps 430 and body straps 440 preferably sandwich between support distributor 530 and support connector 535. In use, when handle 420 is lifted, neck wrap straps 430 and body straps 440 are preferably separated by support distributor 530, in effect preventing neck wrap straps 430 and body straps 440 from pinching together and subsequently squeezing the subject animal. Support connector 535 preferably couples handle 420 to support distributor 530, preferably transferring lift from handle 420 to support distributor 530 and neck wrap straps 430 and body straps 440, preferably to lift and support the subject animal.

Removable handle subsystem 410 preferably further comprises at least one calming fin 520. Calming fin 520 preferably applies light pressure to a calming pressure point on the subject animal, when in use. Specifically, Applicant has found through experimentation that household cats have a calming pressure point between the shoulder blades of the forelegs. When placed in alternate pet restraint device 400, calming fin 520 is positioned to apply light pressure to the calming pressure point noted by Applicant. In addition to the restraining features of alternate pet restraint device 400, the addition of calming pressure placed on the calming pressure point aids in the safe, secure, and stress reduced handling of the subject animal. Applicant theorizes that other quadrupeds (with claws) also have similar calming pressure points that may be utilized in a similar fashion. Upon reading the teachings of this specification, those skilled in the art will now appreciate that, under appropriate circumstances, considering such issues as cost, subject animal, etc., other calming pressure point engagers, such as, for example, nubs, ribs, bars, etc., may suffice.

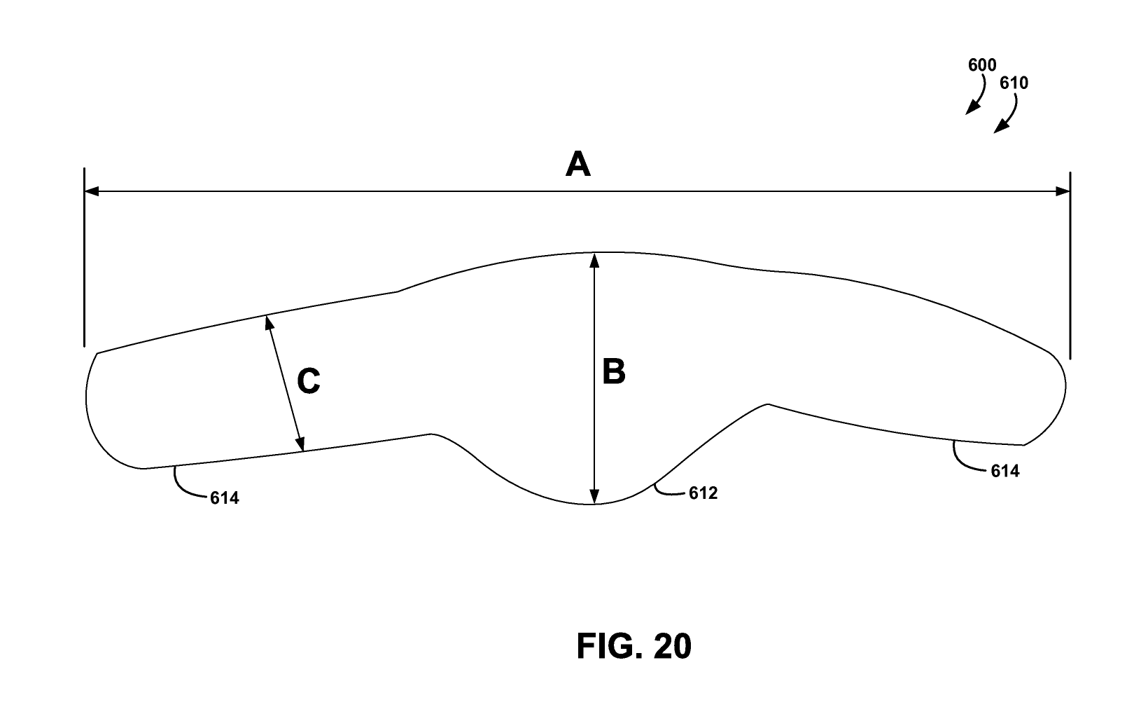

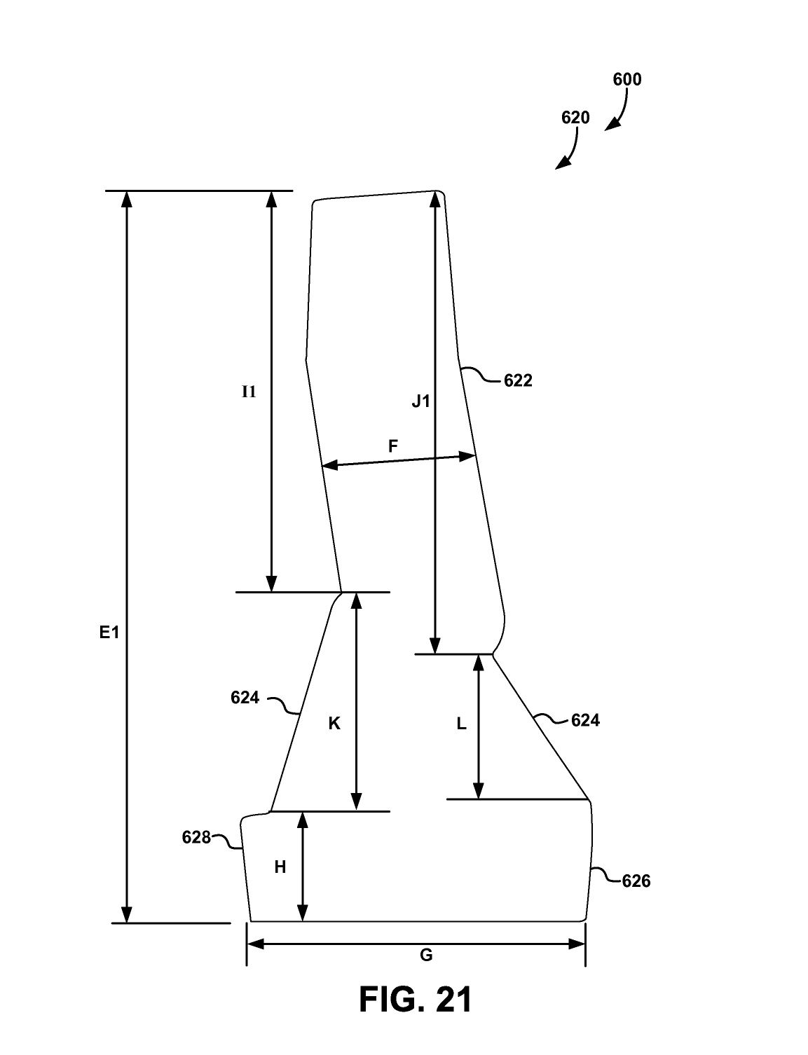

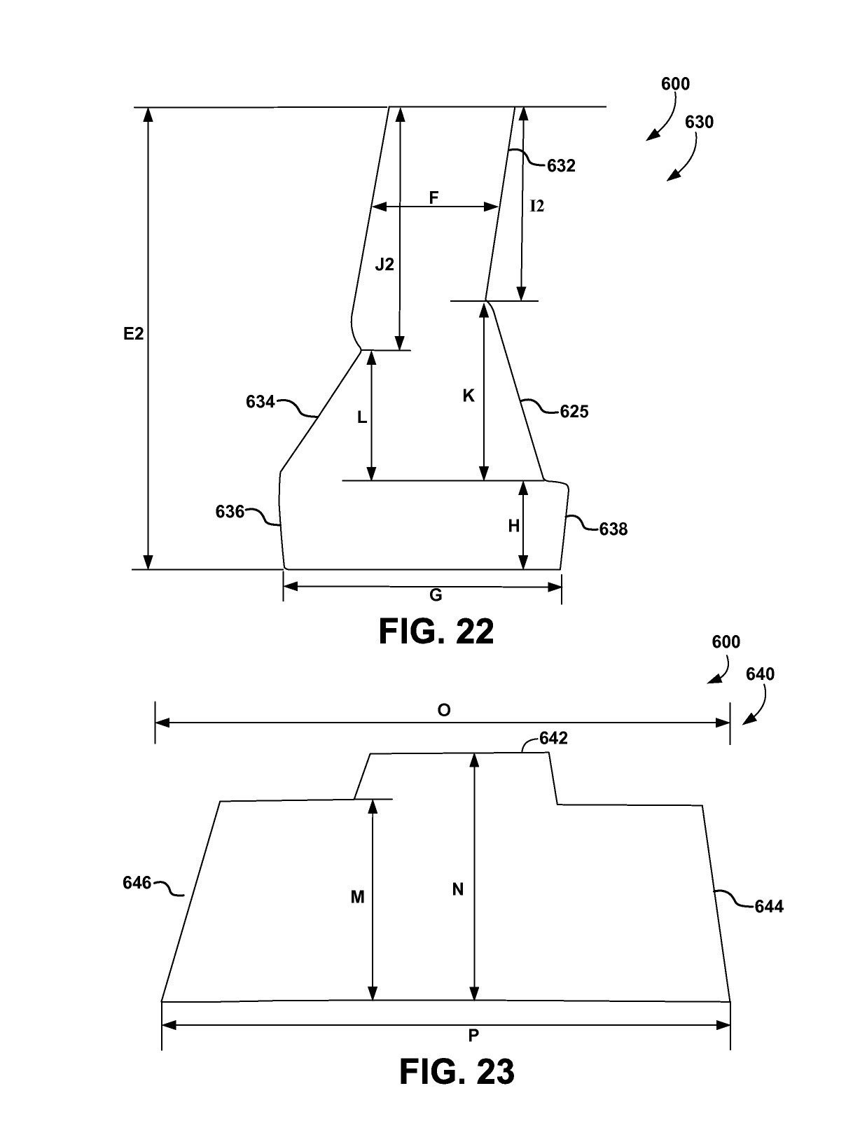

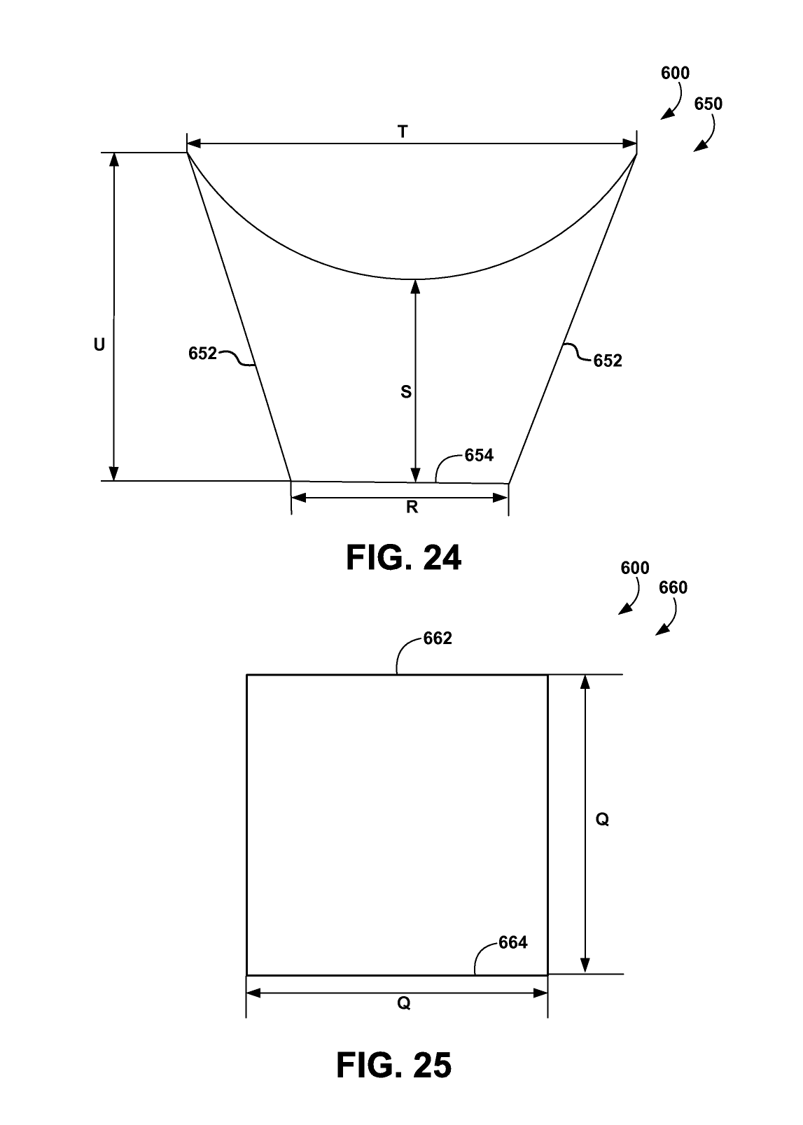

FIG. 20 through FIG. 25 show a plan view, illustrating a flat pattern 600 of alternate pet restraint device 400, according to the preferred embodiment of FIG. 14. Flat pattern 600 preferably comprises the following pattern pieces: neck wrap piece 610; long body-leg piece 620; short body-leg piece 630; leg connector piece 640; chest piece 650; and neck connector piece 660.

Flat pattern 600 preferably constructs outer layer 467, body wrap 470, and neck wrap 480 as a unified piece. Piece edge 612 preferably connects to piece edge 662. Piece edge 626 preferably connects to piece edge 628, forming outer layer 467 from leg restraint portion 624. Piece edge 644 connects to surface of leg restraint portion 624. Piece edge 636 preferably connects to piece edge 638, forming outer layer 467 from leg restraint portion 634. Piece edge 646 connects to surface of leg restraint portion 634. Piece edge 642 preferably connects to piece edge 654. Piece edge 656 preferably connects to piece edge 664. Piece edge 625 preferably connects to piece edge 652. During use, flap 622 and flap 632 removably connect to enclose body wrap 470. Likewise, during use, flaps 614 engage each other to removably connect and enclose neck wrap 480.

Sizes of dimensions, depicted in FIG. 20 through FIG. 25, relating to flat pattern 600, for use on an average household cat preferably comprise the approximate values presented in Table 1.

Although applicant has described applicant's preferred embodiments of this invention in use on domesticated house cats, Applicant recognizes that various quadrupeds may be fitted with restraint devices described herein by adjusting the relative sizes of the various components herein described. Applicant envisions use on dogs, cattle, large cats, primates, bears, badgers, weasels, otters, civets, rodents, beavers, squirrels, hares, rabbits, elephants, hippopotami, rhinoceroses, tapirs, giraffes, camels, llamas, swine, equine, oxen, sheep goats, antelope, elk, deer, moose, opossums, kangaroos, ant-eaters, and armadillos. While not all of these animals may be considered “pets”, often zoo and wildlife caregivers may be in situations where an adapted restraint device of Applicant's general design may aid the care of such animals. Table 2 contains approximate value ranges derived for various animals to adjust the sizing of Applicant's restraint devices. The chest circumference is to be measured just behind the front two appendages when facing the animal. The leg measurement is to be at the shoulder to the bottom of the foot as the animal is standing unassisted and being supported by the two front appendages.

TABLE 1

| Dimen- | Value | Value | Dimen- | Value | Value |
|---|---|---|---|---|---|
| sion | (inches) | (cm) | sion | (inches) | (cm) |
| A | 13 | 33 | B | 3¼ | 8¼ |
| C | 1¾ | 4½ | E1 | 14 | 35½ |
| E2 | 9½ | 24 | F | 2⅞ | 7⅛ |
| G | 6¼ | 15⅝ | H | 2 | 5 |
| I1 | 7¼ | 18½ | I2 | 2¾ | 7 |
| J1 | 9 | 22¾ | J2 | 4½ | 11½ |
| K | 3¾ | 9½ | L | 3 | 7½ |
| M | 1½ | 3¾ | N | 1¾ | 4½ |
| O | 3½ | 8¾ | P | 4¼ | 10¾ |
| Q | 2 | 5 | R | 2¼ | 5¾ |
| S | 2 | 5 | T | 4¾ | 12 |
| U | 3½ | 8¾ | | | |

TABLE 2

| | Chest Circumference Range | | Leg Size Range | |
|---|---|---|---|---|
| Animal | inches | cm | inches | cm |
| Small Domestic Cats | 4-20 | 10-51 | 3-18 | 8-46 |
| Large Cats | 12-80 | 31-203 | 6-60 | 15-152 |
| Dogs | 4-40 | 10-102 | 3-48 | 8-122 |
| Livestock (small) | 8-80 | 20-203 | 6-60 | 15-152 |
| Livestock (large) | 22-190 | 56-483 | 20-70 | 51-178 |
| Primates | 12-80 | 31-203 | 10-60 | 25-152 |
| Bears | 18-96 | 46-244 | 10-60 | 25-152 |
| Badgers | 10-50 | 25-127 | 6-30 | 15-76 |
| Weasels, Otters, Civets | 6-36 | 15-91 | 6-36 | 15-91 |
| Rodents | 4-32 | 10-81 | 2-22 | 5-56 |
| Beavers | 10-32 | 25-81 | 2-22 | 5-56 |
| Elephants | 32-210 | 81-533 | 24-90 | 61-229 |
| Hippos, Rhinos, Tapirs | 32-190 | 81-483 | 20-70 | 51-178 |
| Giraffes, Camels, Llamas | 20-135 | 51-343 | 20-120 | 51-305 |
| Swine | 12-190 | 31-483 | 20-70 | 51-178 |
| Equine | 22-190 | 56-483 | 20-85 | 51-216 |
| Antelope, Elk, Deer, | 22-170 | 56-432 | 16-78 | 41-198 |
| Moose | | | | |
| Marsupials, Ant-Eaters, | 12-60 | 31-152 | 3-40 | 8-102 |
| Armadillos | | | | |

Although applicant has described applicant's preferred embodiments of this invention using metric standardized units, such measurements have been provided only for the convenience of the reader and should not be read as controlling or limiting. Instead, the reader should interpret any measurements provided in English standardized units as controlling. Any measurements provided in metric standardized units were merely derived through strict mechanical coding, with all converted values rounded.

Although applicant has described applicant's preferred embodiments of this invention, it will be understood that the broadest scope of this invention includes modifications such as diverse shapes, sizes, materials and non-conflicting combinations of elements. Such scope is limited only by the below claims as read in connection with the above specification. Further, many other advantages of applicant's invention will be apparent to those skilled in the art from the above descriptions and the below claims.

What is claimed is:

1) A system, relating to the protective restraint of clawed quadrupeds during hygienic-care procedures, comprising:
a) at least one bilateral forelimb restrainer structured and arranged to contemporaneously restrain both forelimbs of the clawed quadruped;
b) wherein said at least one bilateral forelimb restrainer comprises
i) at least one radial-ulnar restrainer structured and arranged to restrain motion of radial-ulnar portions of the forelimbs,
ii) at least one shoulder-motion restrainer structured and arranged to restrain at least rotational motion of the forelimbs about respective shoulder joints, and
iii) at least one liquid passage structured and arranged to enable passage of at least one liquid to exterior portions of the forelimbs during the hygienic-care procedures;
c) wherein the restraint of the forelimbs by said at least one shoulder-motion restrainer prevents removal of the at least one radial-ulnar portion from said at least one radial-ulnar restrainer; and
d) wherein said at least one radial-ulnar restrainer provides to the forelimbs a range of motion independent of said at least one radial-ulnar restrainer during such restraint.

2) The system according to claim 1 wherein, during such restraint, said at least one bilateral forelimb restrainer provides unrestricted access to anatomical portions of the clawed quadrupeds at least posterior to a transverse plane bisecting the thoratic and lumbar vertebrae.

3) The system according to claim 1 further comprising:
a) at least one head shield structured and arranged to shield a head portion of the clawed quadruped;
b) wherein such shielding reduces the potential for biting during the hygienic-care procedures.

4) The system according to claim 3 wherein said at least one bilateral forelimb restrainer comprises said at least one head shield.

5) The system according to claim 1 wherein:
a) said at least one bilateral forelimb restrainer further comprises at least one hand grip structured and arranged to assist hand gripping of said at least one bilateral forelimb restrainer;
b) wherein manual manipulation of the clawed quadruped is assisted during the hygienic-care procedures.

6) The system according to claim 1 wherein said at least one bilateral forelimb restrainer comprises at least one size adjuster structured and arranged to assist size adjustment of said at least one bilateral forelimb restraint to accommodate variously-size clawed quadrupeds.

7) The system according to claim 6 wherein said at least one size adjuster comprises at least one size-adjustment strap.

8) The system according to claim 7 wherein said at least one size-adjustment strap is releasably secured by at least one hook-and-loop fastener.

9) The system according to claim 1 wherein said at least one bilateral forelimb restrainer further comprises at least one bilateral foot cover structured and arranged to bilaterally cover at least one foot portion of the forelimbs.

10) The system according to claim 9 wherein said at least one bilateral foot cover is structured and arranged to be removably attached to said at least one bilateral forelimb restrainer.

11) The system according to claim 1 wherein said at least one bilateral forelimb restrainer is constructed from at least one flexible material.

12) The system according to claim 1 wherein said at least one bilateral forelimb restrainer is constructed from at least one waterproof resilient polymer.

13) A system, relating to the protective restraint of a cat during bathing, comprising:
a) at least one bilateral forelimb restrainer structured and arranged to contemporaneously restrain both forelimbs of the cat;
b) wherein said at least one bilateral forelimb restrainer comprises
i) at least one radial-ulnar restrainer structured and arranged to restrain motion of radial-ulnar portions of the forelimbs,
ii) at least one shoulder-motion restrainer structured and arranged to restrain at least rotational motion of the forelimbs about respective shoulder joints, and
iii) at least one liquid passage structured and arranged to enable passage of at least one liquid to exterior portions of the forelimbs during the bathing;
c) wherein the restraint of the forelimbs by said at least one shoulder-motion restrainer prevents removal of the at least one radial-ulnar portion from said at least one radial-ulnar restrainer;
d) wherein said at least one radial-ulnar restrainer provides to the forelimbs a range of motion independent of said at least one radial-ulnar restrainer during such restraint;
e) wherein, during such restraint, said at least one bilateral forelimb restrainer provides unrestricted access to anatomical portions of the cat at least posterior to a transverse plane bisecting the thorax; and
f) at least one neck restraint structured and arranged to restrain a neck portion of the cat;
g) wherein such restraint reduces the potential for biting during the hygienic-care procedures.

14) The system according to claim 13 wherein said at least one bilateral forelimb restrainer comprises at least one head shield.

15) The system according to claim 13 wherein:
a) said at least one bilateral forelimb restrainer further comprises at least one hand grip structured and arranged to assist hand gripping of said at least one bilateral forelimb restrainer;
b) wherein manual manipulation of the cat is assisted during the hygienic-care procedures.

16) The system according to claim 13 wherein said at least one bilateral forelimb restrainer comprises at least one size adjuster structured and arranged to assist size adjustment of said at least one bilateral forelimb restraint to accommodate variously-size cats.

17) The system according to claim 16 wherein said at least one size adjuster comprises:
a) at least one size-adjustment strap; and
b) said at least one size-adjustment strap is releasably secured by at least one hook-and-loop fastener.

18) The system according to claim 13 wherein said at least one bilateral forelimb restrainer further comprises:
a) at least one bilateral foot cover structured and arranged to bilaterally cover at least one foot portion of the forelimbs;
b) wherein said at least one bilateral foot cover is structured and arranged to be removably attached to said at least one bilateral forelimb restrainer.

19) The system according to claim 13 wherein said at least one bilateral forelimb restrainer is constructed from at least one resilient molded polymer.

20) A system, relating to the protective restraint of clawed quadrupeds during hygienic-care procedures, comprising:
a) bilateral forelimb restraint means for contemporaneously restraining both forelimbs of the clawed quadruped;
b) wherein said bilateral forelimb restraint means comprises
i) radial-ulnar restraining means for restraining motion of radial-ulnar portions of the forelimbs,
ii) shoulder-motion restraining means for restraining at least rotational motion of the forelimbs about respective shoulder joints, and
iii) liquid passing means for enabling passage of at least one liquid to exterior portions of the forelimbs during the hygienic-care procedures;
c) wherein the restraint of the forelimbs by said shoulder-motion restraining means prevents removal of the at least one radial-ulnar portion from said radial-ulnar restraining means; and
d) wherein said radial-ulnar restraining means provides to the forelimbs a range of motion independent of said radial-ulnar restraining means during such restraining

21) The system according to claim 20 wherein, during such restraint, said bilateral forelimb restraint means provides unrestricted access to anatomical portions of the clawed quadrupeds at least posterior to a transverse plane bisecting the thoratic and lumbar vertebrae.

22) The system according to claim 20 further comprising:
a) Neck restraining means for restraining a neck portion of the clawed quadruped;
b) wherein such restraining reduces the potential for biting during the hygienic-care procedures.

23) The system according to claim 22 wherein said bilateral forelimb restraint means comprises head shielding means for shielding a head portion of the clawed quadruped.

24) The system according to claim 20 wherein:
a) said bilateral forelimb restraint means further comprises hand gripping means for assisting hand gripping of said bilateral forelimb restraint means;
b) wherein manual manipulation of the clawed quadruped is assisted during the hygienic-care procedures.

25) The system according to claim 20 wherein said bilateral forelimb restraint means comprises size adjusting means for assisting size adjustment of said bilateral forelimb restraint means to accommodate variously-size clawed quadrupeds.

26) The system according to claim 25 wherein said size adjusting means comprises size adjustment/straps.

27) The system according to claim 20 wherein said bilateral forelimb restraint means further comprises bilateral foot covering means for bilaterally covering at least one foot portion of the forelimbs.

28) The system according to claim 27 wherein said bilateral foot covering means is removably attached to said bilateral forelimb restraint means.
